(19) United States
(12) Patent Application Publication
(10) Pub. No.: US 2010/0300110 A1
(43) Pub. Date: Dec. 2, 2010

(54) Gas Turbine Combustion System With In-Line Fuel Reforming And Methods Of Use Thereof

(75) Inventors: Gilbert Otto Kraemer, Greer, SC (US); Jeffrey Scott Goldmeer, Latham, NY (US); John Thomas Herbon, Rexford, NY (US); Ertan Yilmaz, Glenville, NY (US)

Correspondence Address: CANTOR COLBURN LLP, 20 Church Street, 22nd Floor, Hartford, CT, 06103, US

(73) Assignee: GENERAL ELECTRIC COMPANY, Schenectady, NY (US)

(21) Appl. No.: 12/473,869

(22) Filed: May 28, 2009

(51) Int. Cl. F02C 6/18

(52) U.S. Cl. 60/780

(57) ABSTRACT

A process for providing a fuel supplied to one or more combustors in a gas turbine engine system, comprising: reforming a fraction of the fuel in one or more fuel circuits of the gas turbine combustion system with a plasma reformer system to form at least one of hydrogen and higher order hydrocarbons to be supplied to the one or more combustors with a remaining fraction of the fuel; and controlling at least one of power and fuel flow to the plasma reformer system with an active feedback control system.

### BACKGROUND OF THE INVENTION

This disclosure relates generally to gas turbine engine combustion systems, and more particularly, to methods and apparatus for fuel reforming to enhance the operability of the combustion systems.

Gas turbine engines typically include a compressor section, a combustor section, and at least one turbine section. The compressor discharge air is channeled into the combustor where fuel is injected, mixed and burned. The combustion gases are then channeled to the turbine, which extracts energy from the combustion gases.

Gas turbine engine combustion systems operate over a wide range of flow, pressure, temperature and fuel/air ratio operating conditions. Control of combustor performance, including combustor stability, emissions and dynamics, is required to achieve and maintain satisfactory overall gas turbine engine operation and to achieve acceptable emissions levels, particularly nitrogen oxides (NOx), carbon monoxide (CO), and unburned hydrocarbon (UHC) levels.

One class of gas turbine combustors achieve low NOx emissions levels by employing lean premixed fuel combustion process wherein the fuel and an excess of air that is required to burn all the fuel are mixed prior to combustion to control and limit thermal NOx production. This class of combustors, often referred to as Dry Low NOx (DLN) combustors, are continually required to perform at higher and higher efficiencies while producing less and less undesirable air polluting emissions. Higher efficiencies in DLN combustors are generally achieved by increasing overall gas temperature in the combustion chambers. Emissions are typically reduced by lowering the maximum gas temperature in the combustion chamber. The demand for higher efficiencies which results in hotter combustion chambers conflicts to an extent with the regulatory requirements for low emission DLN gas turbine combustion systems.

The oxidation of molecular nitrogen in gas turbines increases dramatically with the maximum hot gas temperature in the combustion reaction zone of each combustion chamber. The rate of chemical reactions forming NOx is an exponential function of temperature. The volume of NOx emissions can be great even if the hot maximum temperature is reached only briefly. A common method for reducing NOx emissions is to lower the maximum hot gas temperature in the combustion chamber by maintaining a lean fuel-air ratio.

One effect of operating in a lean premixed combustion mode is that the combustor can experience unwanted pressure oscillations. Depending on the magnitude of the oscillation amplitude, these pressure oscillations could damage combustion hardware. In addition, if the fuel-air mixture in a combustion chamber is too lean, however, excessive emissions of carbon monoxide and unburned hydrocarbon can occur. CO and UHC emissions result from incomplete fuel combustion. Generation of these emissions usually occurs where the fuel-air mixture excessively quenches combustion in the reaction zone. The temperature in the reaction zone must be adequate to support complete combustion or the chemical combustion reactions will be quenched before achieving equilibrium.

One method for improving this tradeoff is by adding hydrogen or other non-methane hydrocarbon fuel species to the standard fuel to increase reactivity in the combustor. Through the addition of fully premixed highly reactive fuels to the standard fuel, the combustor head-end can be operated with a lower fuel-to-air ratio while maintaining a stable flame and adequate CO and UHC reactivity for increased engine turn down. Addition of reactive fuels such as hydrogen can enable certain fuel splits that produce lower NOx. This method however, requires additional hydrogen storage onsite, as well as a metering system for injecting the desired amounts of hydrogen into the fuel stream. One current method for eliminating these costs is by reforming the turbine fuel to produce hydrogen within the gas turbine fuel delivery system.

Catalytic reformers have been used to create hydrogen from a fuel to feed to the combustor. The catalytic reformer can be disposed remotely from the combustion system, or it can be disposed within the combustion system in fluid communication with the turbine fuel. By producing hydrogen from the fuel itself, there is no need for on-site hydrogen storage, and in the case of an in-line reformer, no need for a hydrogen metering system. Catalytic reformers, however, can require regular maintenance. For example, the catalyst activity can diminish over time thereby requiring the reformer to be recharged with fresh catalyst. Another potential issue is the reformer catalyst becoming poisoned, preventing the hydrogen from being properly formed from the fuel. In both cases, it will be necessary to change the catalyst. Depending on system design, an increase in exhaust emissions could occur while the catalytic reformer is off-line, or the gas turbine may even have to be taken offline in order to change the catalyst.

Plasmatrons or plasma reformers are devices that employ an electric discharge in order to produce hydrogen-rich gas from hydrocarbons. Plasma reformers, therefore, have been proposed in PCT Publication No. WO03/055794 to Siemens. Plasma reformers are typically smaller than catalytic reformers, such as steam-methane reformers or oxidative reformers. Moreover, plasma reformers do not require reactant feed streams (e.g., hydrogen feed) or the on-site storage associated therewith. On the other hand, additional electrical energy is consumed in generating the plasma. A key benefit of plasma reformers is that they can respond on demand to produce the required concentration of hydrogen and other products to achieve the required system operating goals such as emissions, dynamics and flame stability.

### BRIEF DESCRIPTION OF THE INVENTION

According to one aspect of the invention a process for providing a fuel supplied to one or more combustors in a gas turbine engine system, comprising reforming a fraction of the fuel in one or more fuel circuits of the gas turbine combustion system with a plasma reformer system to form at least one of hydrogen and higher order hydrocarbons to be supplied to the one or more combustors with a remaining fraction of the fuel; and controlling at least one of power and fuel flow to the plasma reformer system with an active feedback control system.

According to another aspect of the invention a gas turbine engine system, comprising a compressor, a plurality of combustors, and a turbine; a fuel system comprising one or more fuel circuits configured to provide fuel to the plurality of combustors; a plasma reformer system in fluid communication with the one or more fuel circuits and configured to reform a fraction of the fuel in the one or more fuel circuits; and a control system configured to regulate at least one of power and fuel flow to the plasma reformer system.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic diagram of a gas turbine engine system.

FIG. 2 is a schematic diagram of an exemplary embodiment of a plasma reformer system disposed in a fuel circuit of the gas turbine engine system of FIG. 1.

FIG. 3 is a schematic diagram of an exemplary embodiment of a side-stream plasma reformer system in fluid communication with a fuel circuit of the gas turbine engine system of FIG. 1.

FIG. 4 is a schematic diagram of an exemplary embodiment of a fuel circuit including a heat exchanger for pre-heating fuel and an expander for lowering fuel inlet pressure.

The detailed description explains embodiments of the invention, together with advantages and features, by way of example with reference to the drawings.

### DETAILED DESCRIPTION OF THE INVENTION

Described herein are gas turbine engine combustion systems, and more particularly, methods and apparatus for in-line fuel reforming to enhance the operability of the combustion systems. The gas turbine engine combustion systems utilize a plasma reformer system in fluid communication with one or more of the fuel circuits to partially reform a small fraction of the fuel and increase fuel reactivity. As used herein, the term “in-line” is generally intended to mean the plasma reformer system is an integral component of the turbine fuel system. The plasma reformer system may be disposed within the fuel control system, and in some embodiments within the fuel flow path of one or more fuel circuits of the fuel control system. The plasma reformer system, therefore, can improve combustor performance such as dynamics, flame stability and emissions, while limiting power consumption by providing on-demand fuel conditioning to a fraction of the fuel within the gas turbine engine combustion system. The plasma reformer is in operative communication with an engine control system to provide the fuel conditioning as required to achieve the required emissions control (e.g., NOx, yellow plume (visible NO₂), etc.) or operability (e.g. combustion pressure oscillations, also known as combustion dynamics or dynamics), while limiting parasitic losses.

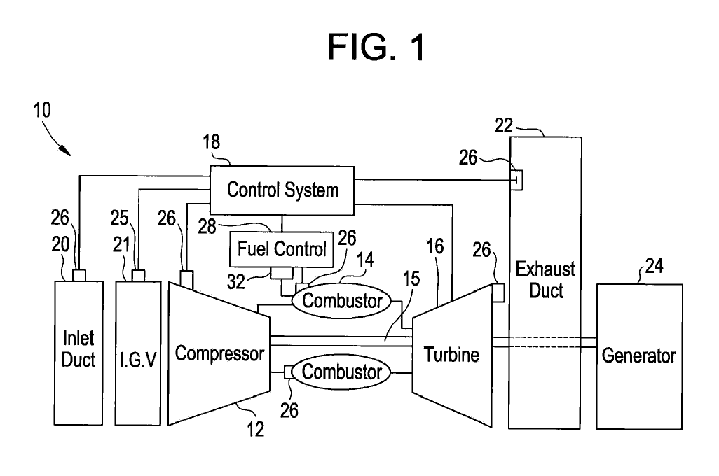

FIG. 1 is a schematic diagram of a gas turbine engine system 10 including a compressor 12, a combustor 14, a turbine 16 coupled by a drive shaft 15 to the compressor 12. As seen in the figure, the system 10 can have a single combustor or a plurality of combustors (two shown in the figure). In one embodiment, the combustors are DLN combustors. In another embodiment, the combustors are lean premixed combustors. The gas turbine engine is managed by a combination of operator commands and a control system 18. An inlet duct system 20 channels ambient air to the compressor inlet guide vanes 21 which, by modulation with actuator 25, regulates the amount of air to compressor 12. An exhaust system 22 channels combustion gases from the outlet of turbine 16 through, for example, sound absorbing, heat recovery and possibly emissions control devices. Turbine 16 may drive a generator 24 that produces electrical power or any other type of mechanical load.

The operation of the gas turbine engine system 10 may be monitored by a variety of sensors 26 detecting various conditions of the compressor 12, turbine 16, generator 24, and ambient environment. For example, sensors 26 may monitor ambient temperature, pressure and humidity surrounding gas turbine engine system 10, compressor discharge pressure and temperature, turbine exhaust gas temperature and emissions, and other pressure and temperature measurements within the gas turbine engine. Sensors 26 may also comprise flow sensors, speed sensors, flame detector sensors, valve position sensors, guide vane angle sensors, and other sensors that sense various parameters relative to the operation of gas turbine engine system 10. As used herein, “parameters” refer to physical properties whose values can be used to define the operating conditions of gas turbine engine system 10, such as temperatures, pressures, fluid flows at defined locations, and the like.

In addition to the above-mentioned sensors 26 there are one or more sensors (not shown) to monitor or measure fuel properties sufficiently to determine the fuel composition prior to and/or after the plasma reformer 32 described below. The sensors may sense one or more of the following: fractional (fuel) composition, hydrogen content, a parameter representative of the fuel modified Wobbe index (MWI), Lower Heating Value (LHV), fuel temperature, and the like.

A fuel controller 28 responds to commands from the control system 18 to continuously regulate the fuel flowing from a fuel supply to the combustor(s) 14, and the fuel splits (independently controlled fuel supply to fuel circuits) to multiple fuel nozzle injectors (i.e., fuel circuits) located within each of the combustor(s) 14. Fuel control system 28 may also be directed by the controller 18 to select the type of fuel or a mix of fuels for the combustor if more than one fuel is available. By modulating fuel splits via the fuel controller 28 among the several fuel gas control valves, and controlling the partial fuel reforming in one or more of the fuel injectors with the control system 18, emissions and dynamics are improved over the machine load range.

The control system 18 may be a computer system having a processor(s) that executes programs to control the operation of the gas turbine using the sensor inputs described above and instructions from additional operators. The programs executed by the control system 18 may include scheduling algorithms for regulating fuel flow, fuel reforming, and fuel splits to combustor(s) 14. More specifically, the commands generated by the control system cause actuators in the fuel controller 28 to regulate the flow to both the plasma reformer 32 and the fuel nozzle injectors; adjust inlet guide vanes 21 on the compressor, and activate the plasma reformer, or control other system settings on the gas turbine.

The algorithms thus enable control system 18 to maintain the combustor firing temperature and exhaust temperature to within predefined temperature limits and to maintain the turbine exhaust NOx and CO emissions to below predefined limits at part-load through full load gas turbine operating conditions. The combustors 14 may be a DLN combustion system, and the control system 18 may be programmed and modified to control the fuel splits for the DLN combustion system according to the predetermined fuel split schedules, modified by a tuning process which occurs after every major combustor and gas turbine maintenance outages to improve emissions and combustion dynamics. Combustor fuel splits are also set by the periodic tuning process to satisfy performance objectives while complying with operability boundaries of the gas turbine. All such control functions have a goal to improve operability, reliability, and availability of the gas turbine.

The plasma reformer system 32 is in fluid communication with the fuel flow of one or more fuel circuits (not shown) in the fuel control system 28. Again, the plasma reformer system 32 is configured to partially reform a small percentage of the fuel to increase fuel reactivity. Partially reforming the fuel increases the fuel reactivity by forming higher order hydrocarbons and hydrogen, which are combined with the remaining fraction of non-reformed fuel. The amount of reforming can be adjusted to increase stability at low turbine load, or enable lower emissions due to the effects of the increased fuel reactivity on lean premixed combustion. The increased chemical reactivity of the fuel can help to greatly reduce the formation of NOx in the combustor. For example, an existing gas turbine combustor will operate at least one of a plurality of fuel nozzles at a flame temperature higher than that of the others in order to help burnout the fuel and CO within a predetermined distance. A more reactive fuel, however, does not require the fuel nozzle to be run at such a high flame temperature. Therefore, as mentioned previously, reducing the maximum flame temperature of the fuel nozzle(s) will greatly reduce the formation of NOx in the combustor. Further, the plasma reformer system 32 can assist the gas turbine engine system 10 during low power, low load conditions, because increasing the fuel reactivity allows the combustor to be turned down further without going out of CO emissions limits.

The plasma reformer system 32 can be used to partially reform any fuel typically used in gas turbine engine combustion systems. Exemplary fuels for partial reformation can include, without limitation, gasoline, diesel fuel, natural gas, jet propellant (JP4), biomass-derived fuels, and other like hydrocarbon-based fuels. The plasma reformer system 32 is configured to reform a small percentage of the fuel to form higher order hydrocarbons and hydrogen. The plasma reformer can reform about 0.1 volume percent (vol %) to about 100 vol % of the fuel, specifically about 1 vol % to about 50 vol %, more specifically about 2 vol % to about 35 vol %, and even more specifically 5 vol % to 20 vol %. The desired percentage of fuel reformed can depend on a number of factors such as, without limitation, turbine load, fuel type, water and/or oxidant additives, fuel temperature, emissions, and the like. The control system 18 can be configured to regulate power input to the plasma reformer system 32 and control the percentage of fuel reformed based on feedback from any of the sensors 26.

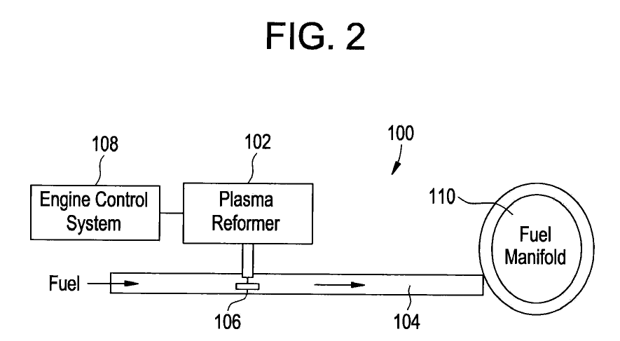

As mentioned, the plasma reformer system can be disposed in any location within fuel system of the gas turbine combustion system wherein the plasma discharge is in-line with at least a portion of the fuel. The plasma reformer system, therefore, can be disposed within one or more fuel circuits of the combustor. An embodiment of a fuel circuit 100 is illustrated in FIG. 2. In this embodiment, a plasma reformer system 102 is disposed within a fuel conduit 104 of the fuel circuit 100 that is configured to feed fuel through a fuel nozzle injector into one of the combustor chambers. The plasma reformer system 102 is positioned such that a portion of the fuel flow in the conduit 104 passes through the plasma discharge 106 of the reformer. The plasma reformer system 102 is in electrical communication with an engine control system 108. The engine control system 108 is configured to regulate at least the percentage reformation of the fuel by controlling the power to the plasma reformer 102 and/or the fuel flow through the plasma discharge 106.

While the plasma reformer system 102 can be disposed at any point in the fuel circuit 100, FIG. 2 shows the reformer disposed upstream of the fuel manifold 110. Such a plasma reformer location can prevent loss of existing combustion system operability should the reformer fail. Because the reformer is located upstream of the fuel manifold, the flow from the fuel circuit 100 to the combustor can be simply turned off, while the gas turbine combustion system continues to operate with the remaining circuits. This particular location also provides an easy access point in the combustion system for both installation and service. Still another benefit to disposing the plasma reformer system 102 in the fuel circuit 100 is potentially eliminating the need for active cooling of the plasma reformer. Plasma reformers can generate significant heat, which needs to be cooled over time. In some plasma reformer systems it is necessary to run cooling water lines to the reformer and cool the system. When the plasma reformer is disposed in the fuel conduit 104, however, the fuel can provide passive cooling to the reformer. The flow rate of the fuel passing the plasma reformer is effective to cool the reformer and eliminate the need for additional cooling, installation of water lines, and the like.

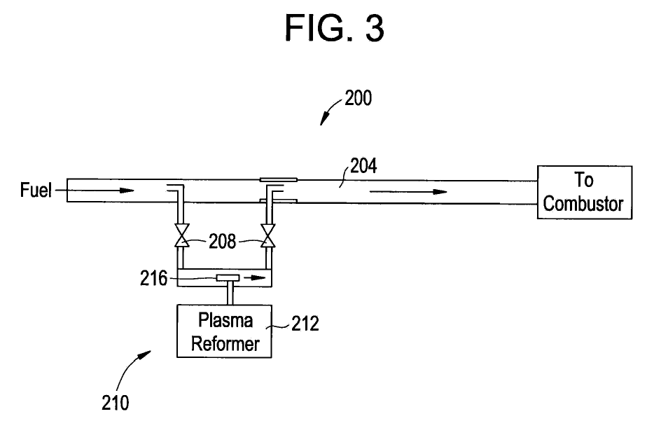

FIG. 3 illustrates another exemplary embodiment of a plasma reformer system 210 in fluid communication with a fuel circuit 200. In this embodiment, the plasma reformer 212 is disposed outside the fuel conduit 204. A portion of the fuel from the fuel conduit 204 can be diverted into the plasma reformer system 210 through the operation of by-pass valves 208. A side stream of the fuel passes through the plasma discharge 216, wherein the fuel is converted to higher order hydrocarbons and hydrogen. The by-pass valves 208 can be disposed at the inlet and outlet locations of the plasma reformer system 210 to actively control fuel flow thereto. The by-pass valves 208, as well as the plasma reformer 212, can be in operative communication with an engine control system to provide on-demand reformation of a portion of the turbine fuel. Moreover, with the by-pass valves 208, the side-stream plasma reformer system 210 can be isolated from the fuel circuit 200 and serviced without interruption of the fuel flow to the gas turbine combustor.

The plasma reformer systems described herein are in operative communication with an engine control system configured to provide on-demand functionality to the plasma reformer. The control system monitors process conditions, such as temperatures and pressures, throughout the gas turbine engine combustion system. Such a control system can be employed to adjust fuel feed rates and/or plasma gas feed rates, to control power to the plasma reformer, monitor plasma discharge conditions, adjust supplementary process gas feed rates (e.g., oxidizers), or control other like conditions within the gas turbine system. A fuel gas analysis subsystem can further be included to provide additional feedback to such a control system. The control system can operate and control the plasma reformer based on any number of process parameters. Feedback from sensors, thermocouples, and the like alert the control system to various conditions within the gas turbine system. Exemplary process parameters can include, without limitation, temperature (e.g., fuel temperature, nozzle temperature, combustor temperature, and the like), humidity, inlet pressure loss, dynamic pressure, exhaust backpressure, exhaust emissions (e.g., NOx, CO, UHC, and the like), turbine load/power, and the like. This feedback loop between the parameters monitoring and the control system can indicate the need to alter the reactivity of the fuel, and therefore, activate the plasma reformer. When certain parameters reach a predetermined target, it may be suitable to cease further reforming and deactivate the plasma reformer. Moreover, the plasma reformer is a surrogate power drain to the gas turbine system as it reforms the fuel. Therefore, it is desirable to power off the plasma reformer when it is not necessary for emissions control and/or turbine operability. For example, the plasma reformer can be used to reform a fraction of the fuel when the turbine is operating at low-load conditions where a small energy drain from the reformer is not detrimental to the power output of the turbine. However, at full load conditions, such as, for example, peak energy demand periods, the plasma reformer can be turned off to eliminate the energy drain therefrom.

As mentioned previously, the plasma reformer system can be disposed in one more fuel circuits of the gas turbine engine combustion system. The plasma reformer system can be tuned to vary the hydrocarbon species formed by the fractional fuel reformation. Again, the plasma reformer is configured to reform a fraction of the fuel in the fuel circuit to produce hydrogen, higher order (i.e., larger) hydrocarbons than the unreformed fuel hydrocarbons, or some combination of the two. For example, the plasma reformer can convert natural gas (methane) to hydrogen and/or more reactive hydrocarbons. In an exemplary embodiment, the fuel has a hydrogen content of less than or equal to about 66 vol % after plasma reformation, specifically less than or equal to about 15 vol %, more specifically less than or equal to about 5 vol %, based on 100% methane fuel. Limiting the hydrogen content of the reformed fuel can help to prevent sealing problems in the fuel nozzle injectors. When hydrogen content is too great, standard seals in the nozzles of DLN combustion systems can leak or fail over time. The ability to tune the plasma reformer system to control the species produced is advantageous, because the system can produce a number of more reactive hydrocarbon systems that will make the fuel similarly reactive to hydrogen, but will not have the detrimental affect to sealing that can occur with high hydrogen concentrations. Exemplary higher order hydrocarbons formed by the fuel conditioning can include, without limitation, ethylene, ethane, propylene, 1,2 butadiene, acetylene, and the like. Plasma temperature, plasma type, plasma operating characteristics, specific energy deposition (energy/molecule), and fuel temperature can all affect the product selectivity of the fractional fuel reformation and the energy efficiency of conversion. Further, in other embodiments, an oxidant feed stream can be added to the plasma reformer system. The oxidant, when exposed to the plasma discharge, will also affect the type of reformation undergone by the fuel, thereby changing the reaction product and further affecting the reactivity of the fuel. Exemplary oxidants can include, without limitation, air, oxygen, oxygen-enriched air, water, hydrogen peroxide, methanol, and the like. Moreover, addition of the oxidant can reduce the plasma reformer power requirement, increasing the conversion efficiency for certain products.

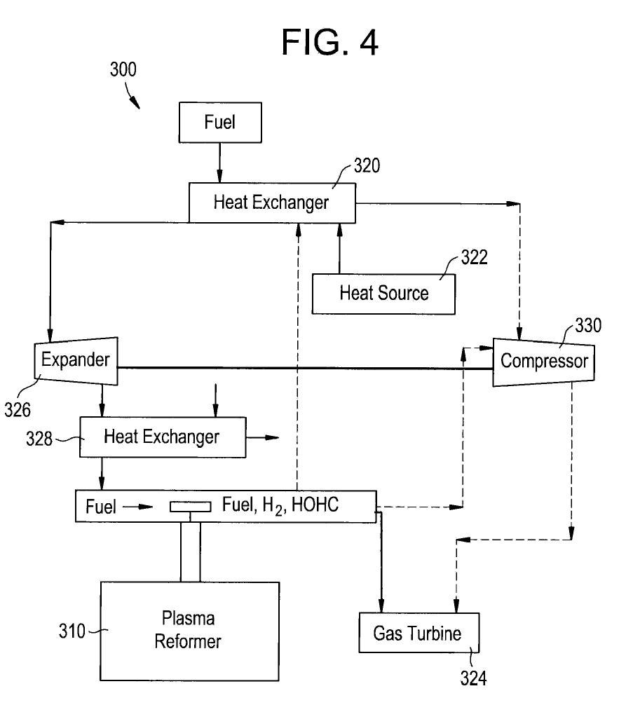

Reforming the fuel at lower pressures and higher inlet temperatures can increase the concentration of reformed products and efficiency in generating them. Fuel break down by the plasma discharge is thermodynamically favored at higher inlet fuel temperatures. The higher order hydrocarbon and hydrogen production, as well as the conversion efficiency, can be increased by increasing the fuel temperature in the fuel circuit of choice. FIG. 4 illustrates an exemplary embodiment of a fuel circuit 300 in a gas turbine engine combustion system, which includes an optional heat exchanger 320 configured to increase the temperature of the fuel therein. The heat exchanger 320 is disposed in fluid communication with the fuel circuit, upstream of the plasma reformer system 310 so that the fuel temperature can be improved prior to exposure to the plasma discharge. The heat exchanger 320 utilizes a heat source 322 for increasing the temperature of all or a portion of the fuel in the fuel circuit 300. In one embodiment, the heat source 322 can be the exhaust gas from the gas turbine 324. After reformation of a fraction of the heated fuel by the plasma reformer, the fuel stream can be optionally cooled before injection to the combustor chamber. In another optional embodiment, the fuel circuit 300 can comprise an expander 326 (e.g., a turbo expander) configured to lower the inlet pressure of the fuel to the plasma reformer. By employing the expander 326, overall system thermal efficiency can be enhanced. An optional heat exchanger 328 can be disposed in fluid communication between the expander 326 and the plasma reformer system 310 to increase the temperature of the expanded fuel. A compressor 330 can be optionally disposed on a downstream end of the fuel circuit so as to increase the pressure (i.e., recompress) of the recombined fuel (reformed fraction and unreformed fraction) to a level that is suitable for the particular gas turbine fuel delivery system being used. In still another optional embodiment, the recombined fuel stream can be cooled via heat exchanger 320 prior to being compressed in the compressor 330.

The in-line plasma reformer system and method of its use in a gas turbine engine combustion system as described herein can advantageously reform a portion of fuel in one or more fuel circuits to increase the fuel reactivity. The plasma reformer system is in operative communication with an active feed back control system to provide fuel conditioning as required to achieve desired emissions (e.g., NOx, CO, yellow plume, turn down, and the like) or operability (e.g., dynamics, and the like), while reducing parasitic energy losses. Moreover, the plasma reformer system is disposed upstream of the fuel manifold for easy installation and service access without loss of existing combustor operability should the plasma reformer fail. Again, increasing the reactivity of the fuel on-demand with the plasma reformer system can alter exhaust emissions, turn down, and dynamics of the gas turbine engine combustion system.

The terminology used herein is for the purpose of describing particular embodiments only and is not intended to be limiting of the invention. Ranges disclosed herein are inclusive and combinable (e.g., ranges of “up to about 25 vol %, or, more specifically, about 5 vol % to about 20 vol %”, is inclusive of the endpoints and all intermediate values of the ranges of “about 5 vol % to about 25 vol %,” etc.). “Combination” is inclusive of blends, mixtures, alloys, reaction products, and the like. Furthermore, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the stated value and has the meaning dictated by context, (e.g., includes the degree of error associated with measurement of the particular quantity). The suffix “(s)” as used herein is intended to include both the singular and the plural of the term that it modifies, thereby including one or more of that term (e.g., the colorant(s) includes one or more colorants). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

Unless otherwise defined, all terms (including technical and scientific terms) used herein have the same meaning as commonly understood by one of ordinary skill in the art to which the embodiments of the invention belong. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A process for providing a fuel supplied to one or more combustors in a gas turbine engine system, comprising:
reforming a fraction of the fuel in one or more fuel circuits of the gas turbine combustion system with a plasma reformer system to form at least one of hydrogen and higher order hydrocarbons to be supplied to the one or more combustors with a remaining fraction of the fuel; and
controlling at least one of power and fuel flow to the plasma reformer system with an active feedback control system.

2. The process of claim 1, further comprising adding an oxidant to the plasma reformer system.

3. The process of claim 2, wherein the oxidant comprises air, oxygen, oxygen-enriched air, water, or a combination comprising at least one of the foregoing.

4. The process of claim 1, further comprising heating the fraction of the fuel prior to reforming.

5. The process of claim 1, further comprising cooling the plasma reformer system by feeding the remaining fraction of the fuel about the plasma reformer system.

6. The process of claim 1, wherein the controlling at least one of power and fuel flow to the plasma reformer system further comprises monitoring a selected one or more of fuel temperature, fuel composition, fuel lower heating value, fuel modified Wobbe index, humidity, inlet pressure loss, dynamic pressure, exhaust backpressure, exhaust emissions, and turbine load.

7. The process of claim 1, wherein the fraction of the fuel after reforming combined with the remaining fraction of the fuel has a total hydrogen concentration of less than or equal to about 66 volume percent.

8. A gas turbine engine system, comprising:
a compressor, a plurality of combustors, and a turbine;
a fuel system comprising one or more fuel circuits configured to provide fuel to the plurality of combustors;
a plasma reformer system in fluid communication with the one or more fuel circuits and configured to reform a fraction of the fuel in the one or more fuel circuits; and
a control system configured to regulate at least one of power and fuel flow to the plasma reformer system.

9. The system of claim 8, wherein the plasma reformer system is disposed in-line of a fuel conduit of one or more of the fuel circuits.

10. The system of claim 8, wherein the plasma reformer system is disposed upstream of a fuel manifold in the one or more fuel circuits.

11. The system of claim 8, wherein one or more of the fuel circuits comprise a side stream in fluid communication with the plasma reformer system, wherein the side stream is configured to divert the fraction of the fuel to the plasma reformer system.

12. The system of claim 11, further comprising one or more by-pass valves configured to control the flow of the fuel to the side stream.

13. The system of claim 8, wherein the fraction of the fuel is reformed to produce a selected one or both of hydrogen and higher order hydrocarbons.

14. The system of claim 13, wherein the higher order hydrocarbons comprise ethylene, ethane, propylene, 1,2 butadiene, acetylene, or a combination comprising at least one of the foregoing.

15. The system of claim 8, wherein a total amount of the fuel in the one or more fuel circuits after reforming has a total hydrogen concentration of less than or equal to about 66 volume percent.

16. The system of claim 8, wherein the plurality of combustors are Dry Low NOx or lean premixed combustors.

17. The system of claim 8, wherein the fuel system further comprises an expander configured to lower an inlet pressure of the fuel and feed an expanded fuel into the plasma reformer system.

18. The system of claim 17, wherein the fuel system further comprises a heat exchanger in fluid communication with the expander and the plasma reformer system, wherein the heat exchanger is configured to heat the expanded fuel.

19. The system of claim 8, wherein the fuel system further comprises a heat exchanger configured to heat the fuel in one or more of the fuel circuits.
